(19) United States
(12) Patent Application Publication
(10) Pub. No.: US 2026/0295733 A1
(43) Pub. Date: Oct. 1, 2026

(54) APPARATUS FOR MANUFACTURING MEMBRANE ELECTRODE ASSEMBLY AND MEMBRANE ELECTRODE ASSEMBLY MANUFACTURED USING THE SAME

(71) Applicants: Hyundai Motor Company, Seoul (KR); Kia Corporation, Seoul (KR)

(72) Inventors: Ji Woo Choi, Hwaseong (KR); Je Min Kim, Hwaseong (KR)

(21) Appl. No.: 19/316,538

(22) Filed: Sep. 2, 2025

(30) Foreign Application Priority Data
Mar. 31, 2025 (KR) 10-2025-0041326

(51) Int. Cl. B23K 26/364; B23K 26/14; B23K 26/16; B23K 101/36; B23K 103/00; H01M 8/1004

(52) U.S. Cl. CPC B23K 26/364; B23K 26/14; B23K 26/16; H01M 8/1004; B23K 2101/36; B23K 2103/40

(57) ABSTRACT

An automated line fabricates a membrane-electrode assembly (MEA) by first laser-etching micropatterns into a moving strip of release paper. The patterned paper is coated with a first electrode layer and then hot-rolled onto an electrolyte membrane to transfer the layer. The system dries the laminate, peels off the release paper, and can add a second electrode and press the finished stack. The laser produces lines or grids 1-40 micrometer wide, 1-25 micrometer deep, and 1-25 micrometer apart using 3-50 W pulses at 40-500 kHz. The resulting MEA carries 2-10 micrometer-thick first electrode whose protrusions match the etched pattern.

### CROSS-REFERENCE TO RELATED APPLICATION

This application claims under 35 U.S.C. § 119(a) the benefit of Korean Patent Application No. 10-2025-0041326 filed on Mar. 31, 2025, the entire contents of which are incorporated herein by reference.

### BACKGROUND

### Technical Field

The present disclosure relates to an apparatus for manufacturing a membrane electrode assembly (MEA), in which an electrode having a specific shape is produced by laser-patterning a release paper, and to an MEA fabricated using the apparatus.

### Background

A proton exchange membrane fuel cell (PEMFC) includes a membrane electrode assembly having an anode and a cathode on opposite sides of the membrane, along with gas-diffusion layers (GDLs), gas-flow channels, etc.

Because a conventional fuel-cell electrode is a porous, planar layer, it makes broad surface contact with adjacent components—such as the GDL or flow channels—when assembled.

Through previous studies, it has been known that forming a specific shape on the outer surface of an electrode so that a certain space exists between the electrode and a gas diffusion layer when they are coupled to each other may help with gas diffusion into the fuel cell and product management (i.e., water management).

Recently, research has been conducted on methods and apparatuses for manufacturing such electrodes, but a solution for mass production on a large scale has not been presented and new problems are also arising.

Most prior work relies on wafer-level etching or deposition techniques, which limits scalability for commercial production.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to address the above-described problems associated with the preexisting technologies, and the present disclosure in some embodiments provide a membrane electrode assembly capable of improving the performance of a fuel cell and an apparatus for manufacturing the same.

Some embodiments of the present disclosure provide a manufacturing apparatus and method of mass-producing membrane electrode assemblies on a large scale.

The embodiments of the present disclosure are not limited to the above-described embodiments. The embodiments of the present disclosure will become clearer from the following description and may be realized by means and combinations thereof disclosed in the claims.

In some embodiments, an apparatus for manufacturing a membrane electrode assembly is provided. The apparatus comprises a supplier configured to supply a release paper; a marker disposed downstream of the supplier and configured to irradiate a laser beam onto the release paper to form patterns having a predetermined shape on a surface of the release paper; an applicator disposed downstream of the marker and configured to form a first electrode on the patterned surface of the release paper to manufacture an intermediate comprising the release paper and the first electrode; a transferer disposed downstream of the applicator, the transferer comprising a pair of rollers configured to receive the intermediate and laminate the intermediate onto a surface of an electrolyte membrane; and a peeler disposed downstream of the transferer and configured to remove the release paper from the electrolyte membrane.

The marker may include a nozzle unit located above the release paper and configured to emit the laser beam; and a fixing unit located below the release paper and configured to secure the release paper in place.

The fixing unit may include an adsorber configured to adsorb a lower surface of the release paper.

The fixing unit may include clamps configured to grip opposite sides of the release paper and pull the release paper with a preset force; and a support configured to support a lower surface of the release paper to prevent sagging under gravity.

The marker may include a cooling unit configured to supply a cooling gas to the release paper.

The marker may include a suction unit configured to remove dust generated from the release paper.

The marker may irradiate the laser with an intensity of 3 W to 50 W and a frequency of 40 kHz to 500 MHz

The patterns may extend in a length direction of the release paper, be recessed to have a predetermined depth and a predetermined width and be spaced apart from one another by a predetermined distance in a width direction of the release paper.

The patterns may extend in a width direction of the release paper, be recessed to have a predetermined depth and a predetermined width and be spaced apart from one another by a predetermined distance in a length direction of the release paper.

A width of each of the patterns may be about 1 μm to 40 μm.

A depth of each of the patterns may be about 1 μm to 25 μm.

The patterns may be spaced apart from each other by about 1 μm to 25 μm.

The apparatus may further include a dryer disposed between the applicator and transferer and configured to dry the intermediate.

The apparatus may further include an assembler configured to form a second electrode on a surface of the electrolyte membrane opposite the surface on which the intermediate is laminated.

The apparatus may further include a presser disposed between the transferer and the peeler and configured to apply heat and pressure to a laminate of the intermediate and the electrolyte membrane.

In some embodiments, a membrane electrode assembly includes an electrolyte membrane; a first electrode disposed on a first surface of the electrolyte membrane; and a second electrode disposed on a second surface of the electrolyte membrane opposite the first surface. The first electrode includes a layer part attached to the electrolyte membrane and having a predetermined thickness, and protrusions extending outwardly from a surface of the layer part. The protrusions extend in a length direction of the layer part and have a predetermined depth and width and are spaced apart from one another by a predetermined distance in a width direction of the layer part; or extend in the width direction of the layer part and have a predetermined depth and width and are spaced apart from one another by a predetermined distance in the length direction of the layer part.

As discussed, the method and system suitably include use of a controller or processer.

Other aspects and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIG. 1 illustrates an apparatus for manufacturing a membrane electrode assembly according to some embodiments of the present disclosure;

FIG. 2 illustrates a marker according to some embodiments of the present disclosure;

FIG. 3 illustrates a fixing unit according to some embodiments of the present disclosure;

FIG. 4 illustrates a fixing unit according to some embodiments of the present disclosure;

FIG. 5 illustrates a cooling unit according to some embodiments of the present disclosure;

FIG. 6 illustrates a suction unit according to some embodiments of the present disclosure;

FIG. 7 illustrates a pattern of a release paper according to some embodiments of the present disclosure;

FIG. 8 illustrates a pattern of a release paper according to some embodiments of the present disclosure;

FIG. 9 illustrates a release paper according to some embodiments of the present disclosure;

FIG. 10 illustrates an applicator according to some embodiments of the present disclosure;

FIG. 11 illustrates a presser according to some embodiments of the present disclosure;

FIG. 12 illustrates a membrane electrode assembly according to some embodiments of the present disclosure;

FIG. 13 illustrates a membrane electrode assembly according to some embodiments of the present disclosure;

FIG. 14 illustrates a first electrode according to some embodiments of the present disclosure;

FIG. 15 illustrates protrusions according to some embodiments of the present disclosure;

FIG. 16 illustrates protrusions according to some embodiments of the present disclosure;

FIG. 17 illustrates the specifications of the first electrode according to some embodiments of the present disclosure;

FIG. 18 illustrates a current-voltage graph illustrating the performances of membrane electrode assemblies according to Example 1, Example 2, Comparative Example 1, and Comparative Example 2; and

FIG. 19 illustrates a current-voltage graph illustrating the performances of membrane electrode assemblies according to Example 1, Example 3, and Comparative Example 1.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

The above-described aspects, other aspects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of the present disclosure. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the disclosure. Singular expressions may encompass plural expressions, unless they have clearly different contextual meanings.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In the following description of the embodiments, terms, such as “including”, “comprising”, and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

The term “release paper” herein refers to a carrier web whose surface is coated or treated to allow clean separation from a material laminated thereto.

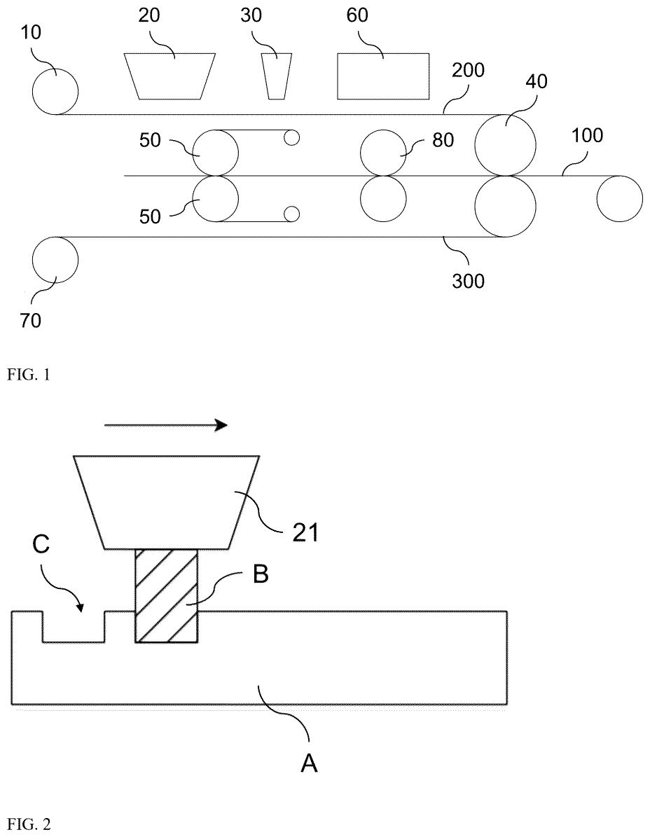

FIG. 1 illustrates an apparatus for manufacturing a membrane electrode assembly according to the present disclosure. The manufacturing apparatus may include a supplier 10 that provides a release paper, a marker 20 that irradiates a laser to the release paper to form a plurality of patterns of a predetermined shape on the surface of the release paper, an applicator 30 that forms a first electrode 200 on the surface of the release paper on which the patterns are formed to manufacture an intermediate including the release paper and the first electrode 200, a transferer 40 that includes a pair of rollers, receives the intermediate and laminates the intermediate onto one surface of an electrolyte membrane 100, and a peeler 50 that removes the release paper.

The supplier 10 may include a cylindrical roll on which the release paper is wound.

The manufacturing apparatus may form the first electrode 200 on the release paper, thermally press the release paper onto the electrolyte membrane 100 to transfer the first electrode 200 to the electrolyte membrane 100 and then remove the release paper. The release paper may be a kind of substrate for transferring the first electrode 200 to the electrolyte membrane 100.

The release paper may include polyethylene naphthalate (PEN), polyethylene terephthalate (PET), polyimide (PI), or the like.

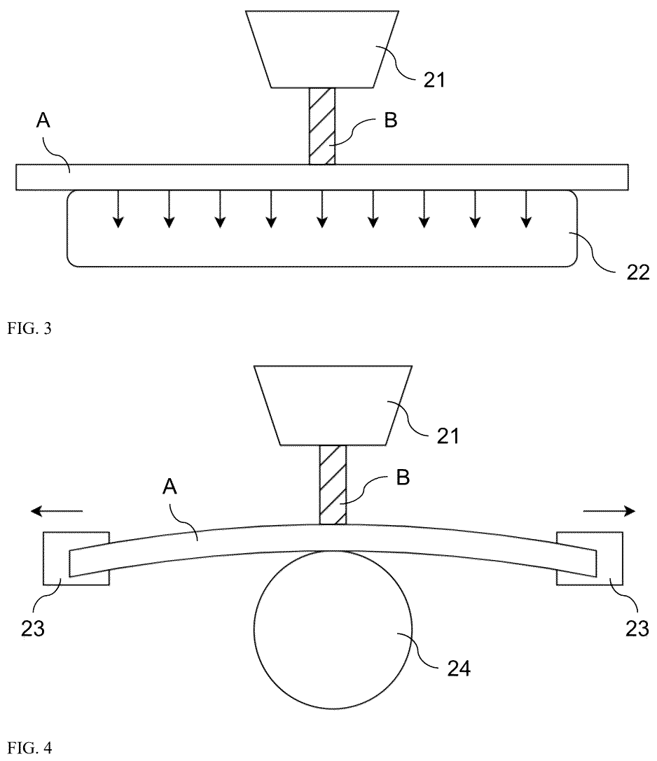

FIG. 2 illustrates the marker 20 according to the present disclosure. The marker 20 may be located at the rear end of the supplier 10, and may form a plurality of patterns C of a predetermined shape on the surface of the release paper A by radiating a laser B to one surface of the release paper A.

The marker 20 may include a nozzle unit 21 located above the release paper A and emitting the laser B.

The laser B may be a carbon dioxide laser, a UV laser, a pico laser, or the like.

The laser B may be a Gaussian beam, a top-hat beam, a flat-top beam, or the like. The Gaussian beam may have an intensity distribution in the form of a Gaussian function, such that the intensity is highest at the center and decreases sharply toward the edge. The top-hat beam may have a flat intensity distribution, such that the intensity of the beam at the center is even and the intensity of the beam may be maintained uniformly within a specific radius or area. The flat-top beam is similar to the top-hat beam but may exhibit a smooth intensity reduction at the edge.

The nozzle unit 21 may irradiate the laser B with an intensity of 3 W to 50 W and a frequency of 40 kHz to 500 MHz. When the intensity and frequency of the laser B are satisfied, the patterns C may be well formed while minimizing damage to the release paper A.

The marker 20 may include a fixing unit that is located below the release paper A and fixes the release paper A. The fixing unit may serve to fix the release paper A to accurately focus when the nozzle unit 21 irradiates the laser B to the release paper A. In addition, the fixing unit may prevent wrinkling and deformation of the release paper A.

FIG. 3 illustrates a fixing unit according to one embodiment of the present disclosure. According to one embodiment, the fixing unit may include an adsorber 22 that adsorbs the lower surface of the release paper A to fix the release paper A. The fixing unit according to one embodiment may fix the release paper A by creating a vacuum state between the release paper A and the adsorber 22. If the release paper A is easily plastically deformed by heat or tension, the adsorber 22 may be employed as the fixing unit.

FIG. 4 illustrates a fixing unit according to another embodiment of the present disclosure. According to another embodiment, the fixing unit may include clamps 23 that clamp both sides of the release paper A and pull the release paper A with a preset force to apply tension to the release paper A, a support 24 that supports the lower surface of the release paper A to prevent sagging of the release paper A in a direction in which gravity acts, and a device configured to spray compressed air onto the lower surface of the release paper A to fix the release paper A. The fixing unit according to another embodiment may be suitable for manufacturing a large-scale membrane electrode assembly because the fixing unit has a simple configuration and strong fixing force.

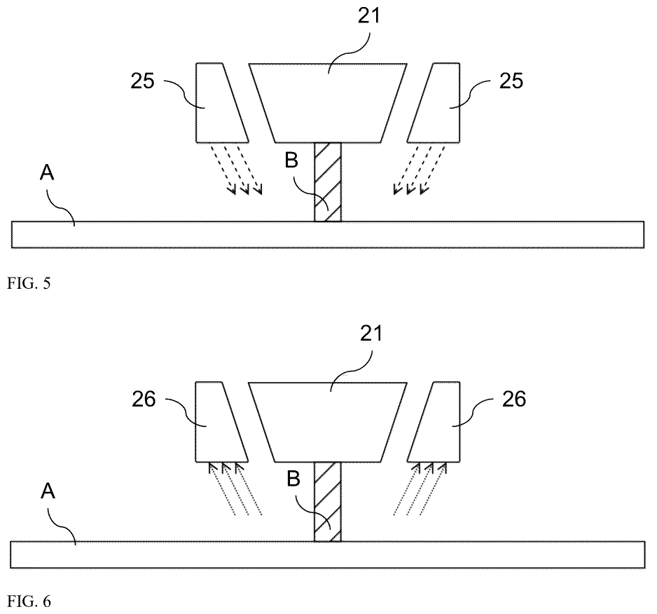

The marker 20 further include a cooling unit 25 that provides cooling gas to the release paper A. FIG. 5 illustrates the cooling unit 25 according to the present disclosure. The cooling unit 25 may prevent the release paper A from melting, rising, and collapsing due to heat generated when radiating the laser B. The cooling unit 25 may be installed near the nozzle unit 21 to provide cooling gas near an area where the laser B is irradiated. However, the configuration of the cooling unit 25 is not limited thereto, and a cooling pad or the like may be installed below the release paper A to cool the release paper A. When using the adsorber 22 as the fixing unit, as shown in FIG. 3, the adsorber 22 may be provided with a cooling function so that the adsorber 22 may perform fixation and cooling at the same time.

The marker 20 may further include a suction unit 26 that suctions dust generated from the release paper A. FIG. 6 illustrates the suction unit 26 according to the present disclosure. The suction unit 26 suctions foreign substances, such as dust generated when radiating the laser B, to prevent the foreign substances from sticking to the release paper A and forming uneven patterns. The suction unit 26 may be installed near the nozzle unit 21 to suction foreign substances, such as dust generated from the release paper A. However, the configuration of the suction unit 26 is not limited thereto, and may be installed anywhere near the release paper A as long as the suction unit 26 may effectively suction foreign substances generated from the release paper A.

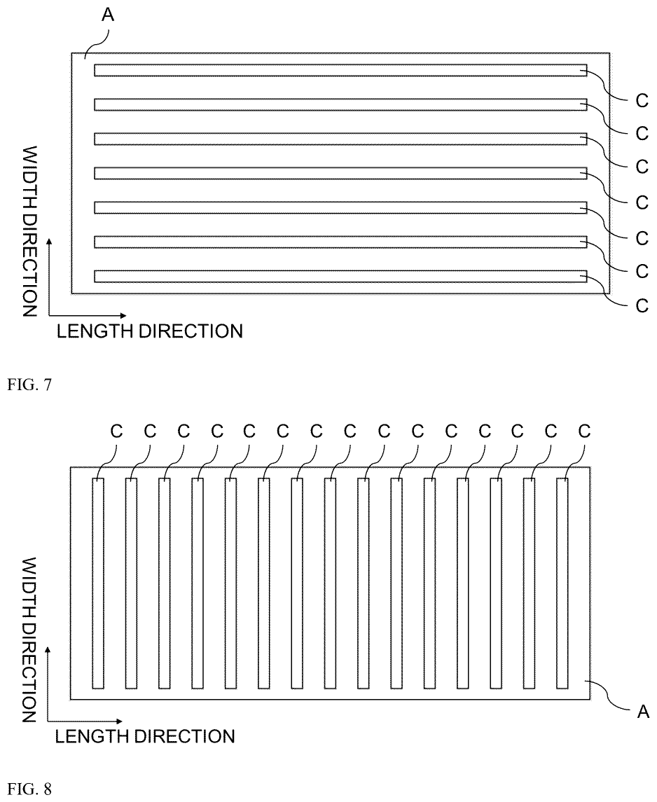

FIG. 7 illustrates patterns C of the release paper A according to one embodiment of the present disclosure. According to one embodiment, the patterns C may be formed to extend in the length direction of the release paper A and be recessed to have a predetermined depth and a predetermined width. When there is a plurality of patterns C, the depths and widths of the respective patterns C may be the same or different. In addition, the plurality of patterns C may be arranged to be spaced apart from each other by a predetermined distance in the width direction of the release paper A. The distance between the plurality of patterns C may be regular or irregular. In addition, some of the plurality of patterns C may be arranged to be spaced apart from each other regularly and the remaining patterns C may be arranged to be spaced apart from each other irregularly. Here, the length direction may be a direction in which the release paper A moves in the manufacturing apparatus, and the width direction may be a direction perpendicular to the length direction.

FIG. 8 illustrates patterns C of the release paper A according to another embodiment of the present disclosure. According to another embodiment, the patterns C may be formed to extend in the width direction of the release paper A and be recessed to have a predetermined depth and a predetermined width. When there is a plurality of patterns C, the depths and widths of the respective patterns C may be the same or different. In addition, the plurality of patterns C may be arranged to be spaced apart from each other by a predetermined distance in the length direction of the release paper A. The distance between the plurality of patterns C may be regular or irregular. In addition, some of the plurality of patterns C may be arranged to be spaced apart from each other regularly and the remaining patterns C may be arranged to be spaced apart from each other irregularly.

As described later, the extension direction and the arrangement direction of protrusions 220 of the first electrode 200 may be determined by controlling the extension direction and the arrangement direction of the patterns C, as shown in FIGS. 7 and 8. When stacking a gas diffusion layer on the first electrode 200, spaces formed by the protrusions 220 and flow channels of the gas diffusion layer may be disposed parallel to each other or be disposed perpendicular to each other between the first electrode 200 and the gas diffusion layer depending on the extension direction and the arrangement direction of the protrusions 220. The parallel disposition or perpendicular disposition may be flexibly adopted depending on the operating method and operating conditions of a fuel cell.

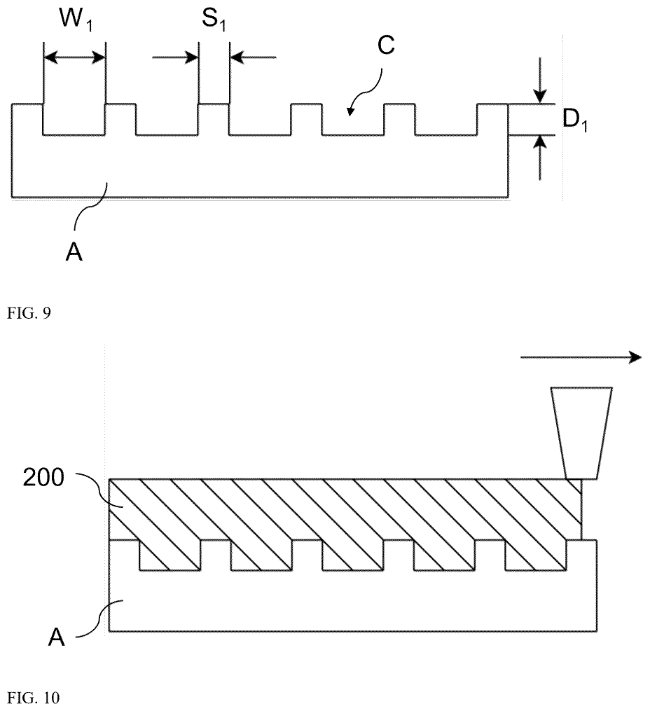

FIG. 9 illustrates the release paper A according to the present disclosure. The width W₁ of the patterns C of the release paper A may be 1 μm to 40 μm, or 1 μm to 30 μm. If the width W₁ is less than 1 μm, it may be difficult to form the patterns C with the laser B, and if the width W₁ exceeds 40 μm, the distance between the protrusions 220 of the first electrode 200 may become too wide, and a contact area between the first electrode 200 and the gas diffusion layer may decrease and cause deterioration in the performance of the fuel cell.

The depth D₁ of the patterns C of the release paper A may be 1 μm to 25 μm. If the depth D₁ is less than 1 μm, an effect of forming the protrusions 220 on the first electrode 200 may be minimal, and if the depth D₁ exceeds 25 μm, the thickness of a layer part 210 of the first electrode 200 excluding the protrusions 220 may become thin, and the first electrode 200 may not function properly.

The distance S₁ between the plurality of patterns C may be 1 μm to 25 μm. If the distance S₁ is within the above range, the protrusions 220 of the first electrode 200 may be formed with an appropriate width and distance without overlapping each other or being too far apart from each other, and flow channels within the first electrode 200 may be well maintained between the first electrode 200 and the gas diffusion layer.

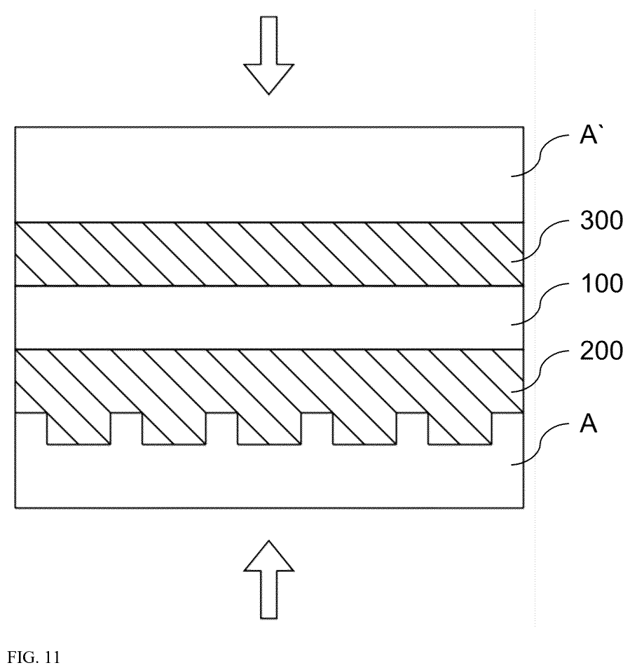

FIG. 10 illustrates the applicator 30 according to the present disclosure. The applicator 30 may be located at the rear end of the marker 20 and may apply an electrode slurry to the surface of the release paper A provided with the patterns C formed thereon after having passed through the marker 20.

The electrode slurry may include a catalyst, an ionomer, an antioxidant, etc. The catalyst may include a support on which a catalyst metal, such as platinum, is supported. The ionomer may include a polymer material having hydrogen ion conductivity, and may include, for example, a perfluoro sulfonic acid polymer, a hydrocarbon polymer, or the like. The antioxidant may include cerium ions, ceria, or the like.

A method of applying the electrode slurry is not particularly limited, and the electrode slurry may be applied using, for example, spraying, slot die, bar coating, or the like.

After the applicator 30 has applied the electrode slurry onto the release paper A, the electrode slurry may be dried through a dryer 60 located at the rear end of the applicator 30 to obtain the intermediate including the release paper A and the first electrode 200 on the release paper A.

The dryer 60 may be located between the applicator 30 and the transferer 40 and dry the electrode slurry. A drying method is not particularly limited, and the electrode slurry may be dried using, for example, thermal drying, infrared drying, ultraviolet drying, or the like.

The transferer 40 may be located at the rear end of the applicator 30, receive the intermediate, and laminate the intermediate onto one surface of the electrolyte membrane 100.

The electrolyte membrane 100 may be supplied from the outside of the transferer 40. The electrolyte membrane 100 may include a polymer having hydrogen ion conductivity, and may include, for example, a perfluoro sulfonic acid polymer, a hydrocarbon polymer, or the like.

The transferer 40 may include a pair of rollers. According to one embodiment of the present disclosure, as a stack in which the first electrode 200 of the intermediate is in contact with one surface of the electrolyte membrane 100 passes through a roll gap between the pair of rollers, the intermediate and the electrolyte membrane 100 may be laminated. Further, according to another embodiment of the present disclosure, as shown in FIG. 1, an assembler 70 may provide a second electrode 300 to the other surface of the electrolyte membrane 100, and the first electrode 200 and the second electrode 300 with the electrolyte membrane 100 interposed therebetween may be supplied to the roll gap to be laminated.

The assembler 70 may provide the second electrode 300 in a flat layered structure, or the same configuration as the marker 20, the applicator 30, and the dryer 60 described above may be located between the assembler 70 and the transferer 40 to provide the second electrode 300 having protrusions formed thereon like the first electrode 200.

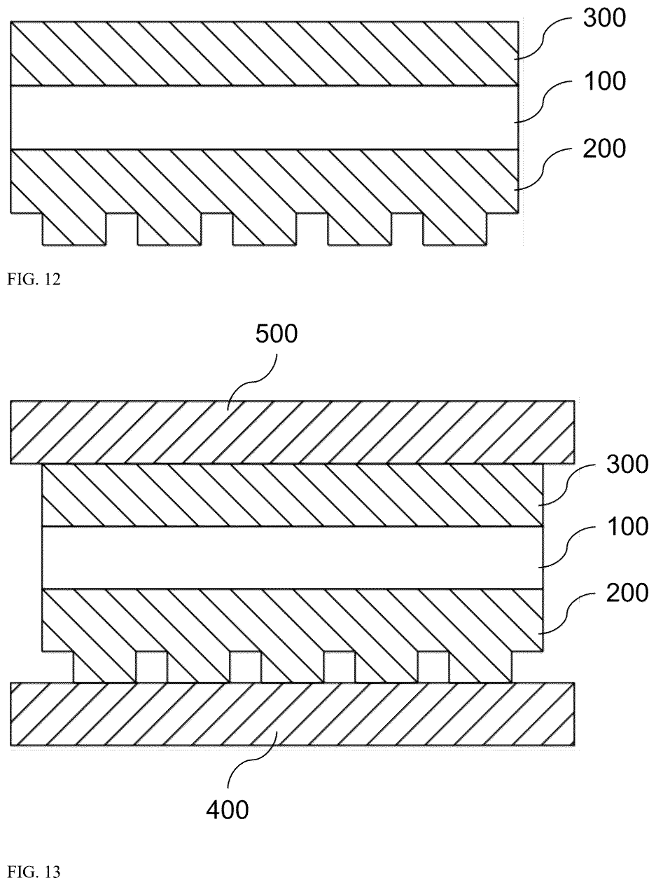

The manufacturing apparatus may further include a presser 80 located at the rear end of the transferer 40 and applying heat and pressure to the stack of the intermediate and the electrolyte membrane 100 and/or the stack of the first electrode 200, the electrolyte membrane 100, and the second electrode 300 to bond the same. FIG. 11 illustrates the presser 80 according to the present disclosure. The presser 80 may apply pressure and heat to the stack including the first electrode 200 and the second electrode 300 with the electrolyte membrane 100 interposed therebetween, the release paper A on the first electrode 200 and a release paper A′ on the second electrode 300 in the stacking direction to bond the respective layers.

The heat and pressure applied by the presser 80 are not particularly limited, and for example, the presser 80 may apply a pressure of 20 MPa or less, or 8 MPa or 10 MPa at a temperature of 0° C. to 150° C., or 120° C. or less.

The peeler 50 is located at the rear end of the transferer 40 and may remove and recover the release paper A. The peeler 50 may also remove the release paper A′ from the second electrode 300, if the manufacturing apparatus includes the assembler 70.

A method of manufacturing a membrane electrode assembly according to the present disclosure may include radiating a laser to one surface of a release paper to form a plurality of patterns of a predetermined shape on the surface of the release paper, applying an electrode slurry to the surface of the release paper provided with the patterns and drying the electrode slurry to form a first electrode, laminating an intermediate including the release paper and the first electrode onto one surface of a electrolyte membrane, and removing the release paper.

In addition, when laminating the intermediate onto one surface of the electrolyte membrane, a second electrode may be laminated onto the other surface of the electrolyte membrane.

In addition, the lamination may be performed by stacking the intermediate and the electrolyte membrane and then applying a pressure to the stack in the stacking direction while heating the stack.

The method of manufacturing the membrane electrode assembly may be performed using the above-described manufacturing apparatus.

FIG. 12 illustrates a membrane electrode assembly according to one embodiment of the present disclosure. The membrane electrode assembly according to one embodiment may include an electrolyte membrane 100, a first electrode 200 located on one surface of the electrolyte membrane 100, and a second electrode 300 located on the other surface of the electrolyte membrane 100.

FIG. 13 illustrates a membrane electrode assembly according to another embodiment of the present disclosure. The membrane electrode assembly according to another embodiment may include an electrolyte membrane 100, a first electrode 200 located on one surface of the electrolyte membrane 100, a second electrode 300 located on the other surface of the electrolyte membrane 100, a first gas diffusion layer 400 located on the first electrode 200, and a second gas diffusion layer 500 located on the second electrode 300.

The electrolyte membrane 100 may serve to transfer hydrogen ions between the first electrode 200 and the second electrode 300. The electrolyte membrane 100 may include a polymer having hydrogen ion conductivity, and may include, for example, a perfluoro sulfonic acid polymer, such as Nafion, or a hydrocarbon polymer.

FIG. 14 illustrates the first electrode 200 according to the present disclosure. The first electrode 200 may include the layer part 210 attached to the electrolyte membrane 100 and having a predetermined thickness, and the plurality of protrusions 220 formed to protrude outwardly from the surface of the layer part 210.

The first electrode 200 may include a catalyst, an ionomer, an antioxidant, etc. The catalyst may include a support on which a catalytic metal, such as platinum, is supported. The ionomer may include a polymer material having hydrogen ion conductivity, and may include, for example, a perfluoro sulfonic acid polymer, a hydrocarbon polymer, or the like. The antioxidant may include cerium ions, ceria, or the like.

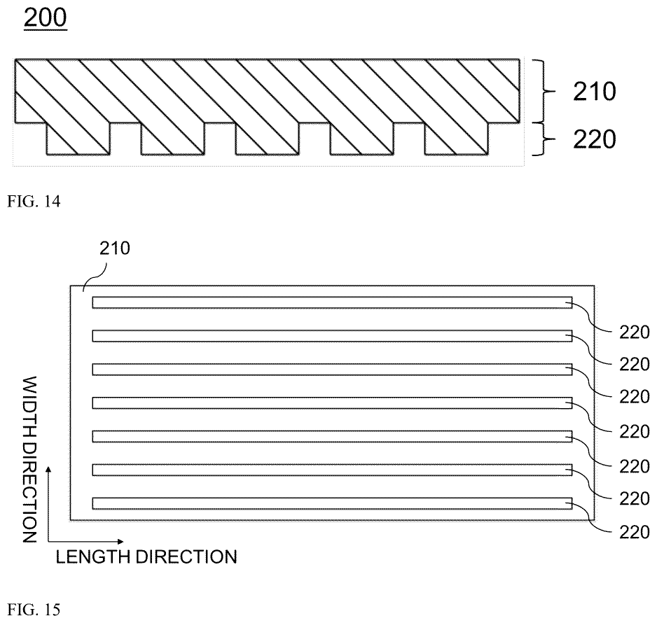

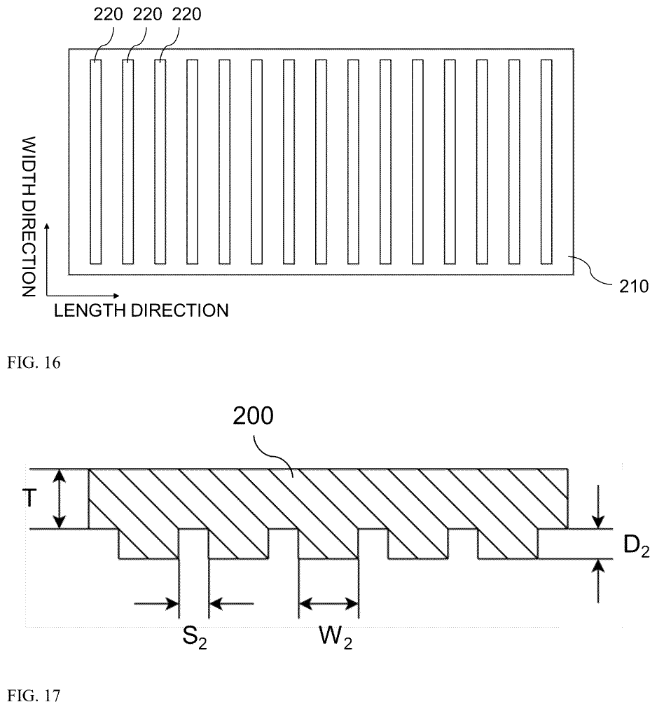

FIG. 15 illustrates protrusions 220 according to one embodiment of the present disclosure. According to one embodiment, the protrusions 220 may be formed to extend in the length direction of the layer part 210 and protrude to have a predetermined depth and a predetermined width. When there is a plurality of protrusions 220, the depths and widths of the respective protrusions 220 may be the same or different. In addition, the plurality of protrusions 220 may be arranged to be spaced apart from each other by a predetermined distance in the width direction of the layer part 210. The distance between the plurality of protrusions 220 may be regular or irregular. In addition, some of the plurality of protrusions 220 may be arranged to be spaced apart from each other regularly and the remaining protrusions 220 may be arranged to be spaced apart from each other irregularly.

FIG. 16 illustrates protrusions 220 according to another embodiment of the present disclosure. According to another embodiment, the protrusions 220 may be formed to extend in the width direction of the layer part 210 and protrude to have a predetermined depth and a predetermined width. When there is a plurality of protrusions 220, the depths and widths of the respective protrusions 220 may be the same or different. In addition, the plurality of protrusions 220 may be arranged to be spaced apart from each other by a predetermined distance in the length direction of the layer part 210. The distance between the plurality of protrusions 220 may be regular or irregular. In addition, some of the plurality of protrusions 220 may be arranged to be spaced apart from each other regularly and the remaining protrusions 220 may be arranged to be spaced apart from each other irregularly.

Depending on the extension direction and the arrangement direction of protrusions 220, the spaces formed by the protrusions 220 and the flow channels of the first gas diffusion layer 400 may be disposed parallel to each other or perpendicular to each other between the first electrode 200 and the first gas diffusion layer 400. The parallel disposition or perpendicular disposition may be flexibly adopted depending on the operating method and operating conditions of the fuel cell.

FIG. 17 illustrates the specifications of the first electrode 200 according to the present disclosure.

The width W₂ of the protrusions 220 may be 1 μm to 40 μm, or 1 μm to 30 μm. If the width W₂ is less than 1 μm, it may be difficult to physically form the protrusions 220, and if the width W₂ exceeds 40 μm, a contact area between the first electrode 200 and the first gas diffusion layer 400 may decrease and cause deterioration in the performance of the fuel cell.

The depth D₂ of the protrusions 220 may be 1 μm to 25 μm. The depth D₂ may mean a length by which the protrusions 220 protrude from the layer part 210 and may be the height of the protrusions 220. If the depth D₂ is less than 1 μm, the effect of forming the protrusions 220 may be minimal, and if the depth D₂ exceeds 25 μm, the thickness of the layer part 210 may become thin, and the first electrode 200 may not function properly.

The distance S₂ between the plurality of patterns 220 may be 1 μm to 25 μm. If the distance S₂ is within the above range, the protrusions 220 may be formed with an appropriate width and distance without overlapping each other or being too far apart from each other, and the flow channels within the first electrode 200 may be well maintained between the first electrode 200 and the first gas diffusion layer 400.

A thickness T of the layer part 210 may be 2 μm to 10 μm. If the thickness T of the layer part 210 exceeds 10 μm, assuming that the loading amount of the catalyst in the first electrode 200 is the same, the protrusions 220 are bound to be relatively small, and thus the effect of forming the protrusions 220 may be minimal.

The second electrode 300 may be an electrode having the opposite polarity to the first electrode 200. The second electrode 300 may have the shape of a flat layer. However, the second electrode 300 may also include a configuration in which portions of one surface thereof protrude outwardly, similar to the first electrode 200, if necessary.

The second electrode 300 may include a catalyst, an ionomer, an antioxidant, etc. The catalyst, ionomer, and antioxidant have been described above, and detailed descriptions thereof will thus be omitted.

The first gas diffusion layer 400 and the second gas diffusion layer 500 may enable reaction gases to be evenly distributed to the first electrode 200 and the second electrode 300, respectively. The first gas diffusion layer 400 and the second gas diffusion layer 500 may be porous layers and may include flow channels allowing the reaction gases to flow therein on the first electrode 200 and the second electrode 300, respectively.

Hereinafter, the present disclosure will be described in more detail through examples. However, the scope of the present disclosure is not limited to the following examples.

### Example 1

A first electrode was manufactured by adjusting a distance between a plurality of protrusions to about 10μm. A membrane electrode assembly, as shown in FIG. 13 was manufactured using the first electrode. Measurements were made in a state in which the extension direction of the protrusions and the direction of flow channels of a first gas diffusion layer were parallel.

### Example 2

A membrane electrode assembly was manufactured in the same manner as in Example 1, except that a distance between a plurality of protrusions was adjusted to about 25 μm.

### Comparative Example 1

A first electrode including only a layer part without forming protrusions was manufactured. Except for this, a membrane electrode assembly was manufactured in the same manner as in Example 1.

### Comparative Example 2

A membrane electrode assembly was manufactured in the same manner as in Example 1, except that a distance between a plurality of protrusions was adjusted to about 100 μm.

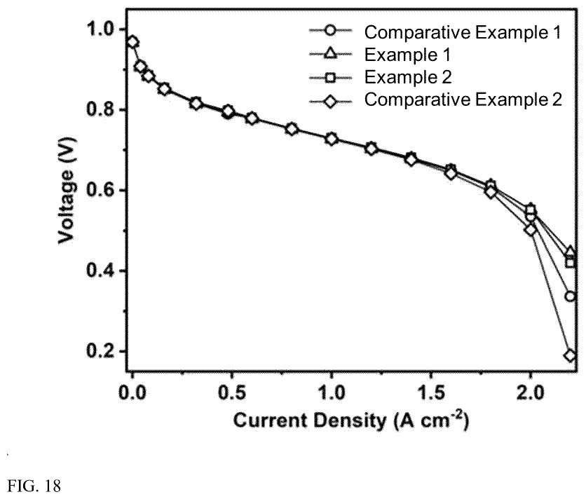

FIG. 18 illustrates a current-voltage graph illustrating the performances of the membrane electrode assemblies according to Example 1, Example 2, Comparative Example 1, and Comparative Example 2. Referring to this figure, it may be confirmed that Example 1 and Example 2 exhibit higher performance than Comparative Example 1. If the protrusions are formed on the first electrode so that spaces exists between the first electrode and the first gas diffusion layer, pores in the electrode may be prevented from being blocked by water generated when a fuel cell is operated and water condensed from humidified air, and oxygen transfer resistance may be reduced, thereby improving the performance of the fuel cell. In addition, Example 1 and Example 2 exhibit higher performance than Comparative Example 2. If the distance between the protrusions exceeds 25 μm, the contact area between the first electrode and the first gas diffusion layer may be reduced, thus reducing the performance of the fuel cell.

### Example 3

A membrane electrode assembly was manufactured in the same manner as Example 1, except that a first gas diffusion layer was attached to a first electrode so that the extension direction of protrusions and the direction of flow channels of the first gas diffusion layer were perpendicular to each other.

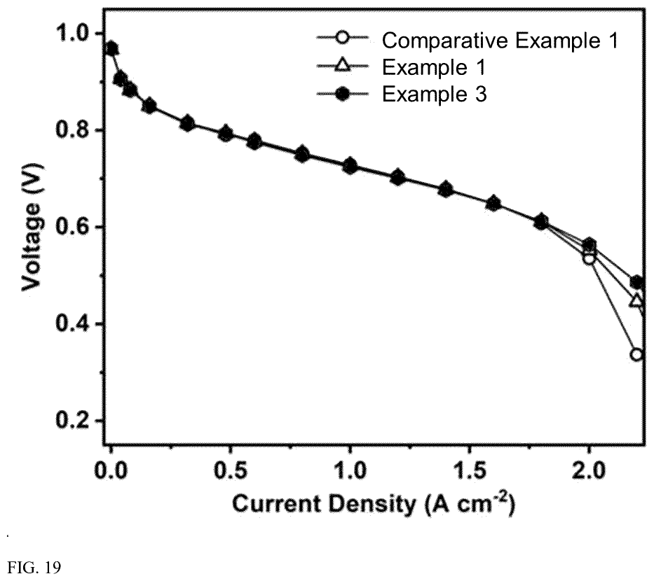

FIG. 19 illustrates a current-voltage graph illustrating the performances of the membrane electrode assemblies according to Example 1, Example 3, and Comparative Example 1. Example 1 and Example 3 exhibit higher performance than Comparative Example 1. A difference in performance of the fuel cell depending on the extension direction of the protrusions is not significant. Therefore, the fuel cell may be made flexibly designed.

As is apparent from the above description, according to the present disclosure, a membrane electrode assembly capable of improving the performance of a fuel cell and a manufacturing apparatus therefor may be obtained.

According to the present disclosure, a manufacturing apparatus and method capable of mass-producing membrane electrode assemblies on a large scale may be obtained.

The effects of the present disclosure are not limited to the above-described effects. It should be understood that the effects of the present disclosure include all effects that may be inferred from the above description.

The embodiments of the present disclosure have been described in detail above, but the scope of the present disclosure is not limited to the above-described embodiments, and various modifications and improvements made by those skilled in the art using the basic concept of the present disclosure defined in the appended claims also fall within in the scope of the present disclosure.

What is claimed is:

1. An apparatus for manufacturing a membrane electrode assembly, the apparatus comprising:
a supplier configured to supply a release paper;
a marker disposed downstream of the supplier and configured to irradiate a laser beam onto the release paper to form patterns having a predetermined shape on a surface of the release paper;
an applicator disposed downstream of the marker and configured to form a first electrode on the patterned surface of the release paper to manufacture an intermediate comprising the release paper and the first electrode;
a transferer disposed downstream of the applicator, the transferer comprising a pair of rollers configured to receive the intermediate and laminate the intermediate onto a surface of an electrolyte membrane; and
a peeler disposed downstream of the transferer and configured to remove the release paper from the electrolyte membrane.

2. The apparatus of claim 1, wherein the marker comprises:
a nozzle unit located above the release paper and configured to emit the laser beam; and
a fixing unit located below the release paper and configured to secure the release paper in place.

3. The apparatus of claim 2, wherein the fixing unit comprises an adsorber configured to adsorb a lower surface of the release paper.

4. The apparatus of claim 2, wherein the fixing unit comprises:
clamps configured to grip opposite sides of the release paper and pull the release paper with a preset force; and
a support configured to support a lower surface of the release paper to prevent sagging under gravity.

5. The apparatus of claim 1, wherein the marker comprises a cooling unit configured to supply a cooling gas to the release paper.

6. The apparatus of claim 1, wherein the marker comprises a suction unit configured to remove dust generated from the release paper.

7. The apparatus of claim 1, wherein the marker irradiates the laser with an intensity of 3 W to 50 W and a frequency of 40 kHz to 500 MHz.

8. The apparatus of claim 1, wherein:
the patterns extend in a length direction of the release paper, are recessed to have a predetermined depth and a predetermined width, and are spaced apart from one another by a predetermined distance in a width direction of the release paper.

9. The apparatus of claim 1, wherein:
the patterns extend in a width direction of the release paper, are recessed to have a predetermined depth and a predetermined width, and are spaced apart from one another by a predetermined distance in a length direction of the release paper.

10. The apparatus of claim 1, wherein a width of each of the patterns is about 1 μm to 40 μm.

11. The apparatus of claim 1, wherein a depth of each of the patterns is about 1 μm to 25 μm.

12. The apparatus of claim 1, wherein the patterns are spaced apart from each other by about 1 μm to 25 μm.

13. The apparatus of claim 1, further comprising a dryer disposed between the applicator and transferer and configured to dry the intermediate.

14. The apparatus of claim 1, further comprising an assembler configured to form a second electrode on a surface of the electrolyte membrane opposite the surface on which the intermediate is laminated.

15. The apparatus of claim 1, further comprising a presser disposed between the transferer and the peeler and configured to apply heat and pressure to a laminate of the intermediate and the electrolyte membrane.

16. A membrane electrode assembly comprising:
an electrolyte membrane;
a first electrode disposed on a first surface of the electrolyte membrane; and
a second electrode disposed on a second surface of the electrolyte membrane opposite the first surface,
wherein the first electrode comprises:
a layer part attached to the electrolyte membrane and having a predetermined thickness, and
protrusions extending outwardly from a surface of the layer part,
wherein the protrusions:
extend in a length direction of the layer part and have a predetermined depth and width, and are spaced apart from one another by a predetermined distance in a width direction of the layer part; or
extend in the width direction of the layer part and have a predetermined depth and width and are spaced apart from one another by a predetermined distance in the length direction of the layer part.

17. The membrane electrode assembly of claim 16, wherein the width of each of the protrusions is about 1 μm to 40 μm.

18. The membrane electrode assembly of claim 16, wherein the depth of each of the protrusions is about 1 μm to 25 μm.

19. The membrane electrode assembly of claim 16, wherein the protrusions are spaced from each other by about 1 μm to 25 μm.

20. The membrane electrode assembly of claim 16, wherein a thickness of the layer part is about 2 μm to 10 μm.
